(19) United States
(12) Patent Application Publication
(10) Pub. No.: US 2003/0117924 A1
(43) Pub. Date: Jun. 26, 2003

(54) Data processor

(76) Inventors: Takuya Shiraishi, Ogaki-shi (JP); Shin-Ichiro Tomisawa, Gifu-ken (JP)

Correspondence Address: FISH & RICHARDSON PC, 225 FRANKLIN ST, BOSTON, MA, 02110, US

(21) Appl. No.: 10/328,407

(22) Filed: Dec. 23, 2002

(30) Foreign Application Priority Data
Dec. 25, 2001 (JP) 2001-391913

(51) Int. Cl. G11B 7/005

(52) U.S. Cl. 369/59.13

(57) ABSTRACT

A data processor for properly conducting various desired diagnostics. The data processor transfers data to and from a recording medium. The data processor includes a processing circuit for performing demodulation or modulation on data having a predetermined format and a switching circuit connected to an input and an output of the processing circuit to output one of input data of the processing circuit and output data of the processing circuit. The switching circuit outputs the input data of the processing circuit when conducting various diagnostics.

### BACKGROUND OF THE INVENTION

The present invention relates to a data processor for transferring data to and from a recording medium, which records modulated data.

When recording data on a recording medium, information data, which is the data that is to be recorded, is modulated to optimally match the data to the characteristics and format configuration of the recording medium. Since the recording medium records the modulated recording data, the recording of data on the recording media and reproduction of the data on the recording medium are performed in a stable manner.

When the recording medium is, for example, a DVD (Digital Versatile Disc), 8-16 modulation is normally performed to modulate information data into recording data. When performing the 8-16 modulation, 8-bit information data is modulated into 16-bit data and a synchronizing signal is added to the data. FIG. 1 shows a DVD recording data format.

As shown in FIG. 1, the DVD recording data includes 32 bits of synchronizing signal (represented by “sync” in FIG. 1) and 1456 bits of modulated information data. The 8-16 modulation converts 728 bits of information data into 1456 bits of data. The 32-bit synchronizing signal is added to the head of the 1456-bit data to generate one frame of recording data. FIG. 1 shows one sector of DVD recording data, which includes 26 frames of recording data.

A DVD data processor includes a demodulation circuit that demodulates recording data, which is read from an optical disc into information data, and a modulation circuit that modulates the information data into recording data. The data processor may further include a circuit for diagnosing the functions of the processor and a DVD, which is used as a recording medium. In such a case, the conversion of data by the modulation circuit and the demodulation circuit may cause problems when conducting diagnostics and tests with the diagnostic circuit.

For example, when diagnosing the condition of the recording data read from the optical disc, the demodulated data is actually detected. Accordingly, a complicated process must be performed to associate the demodulated data with the data prior to demodulation that is recorded on the optical disc. It is thus difficult to determine whether or not the data has been correctly read.

When test writing is performed to determine the recording condition of the data recorded on the optical disc by irradiating a laser beam, modulated test data is actually recorded on the optical disc as a test pattern (modulation test pattern). It is thus difficult to set test data to obtain the desired test pattern.

Furthermore, the test pattern, which is modulated test data, has a very limited frequency (pulse width) and thus may not be able to achieve a waveform that is desired as a test pattern.

The above problems are not limited to a data processor that uses a DVD as a recording medium.

### SUMMARY OF THE INVENTION

It is an object of the present invention to provide a data processor for optimally conducting various diagnostics.

To achieve the above object, the present invention provides a data processor for transferring data to and from a recording medium. The data processor includes a processing circuit for performing at least one of demodulation and modulation on data having a predetermined format and a switching circuit connected to an input and an output of the processing circuit. The switching circuit outputs one of input data of the processing circuit and output data of the processing circuit.

A further aspect of the present invention is a data processor for transferring data to and from a recording medium. The data processor includes a modulation circuit for modulating data recorded on the recording medium and a first switching circuit connected to an input and an output of the modulation circuit. The first switching circuit outputs one of input data of the modulation circuit and output data of the modulation circuit. A demodulation circuit demodulates data read from the recording medium. A second switching circuit is connected to an input and an output of the demodulation circuit. The second switching circuit outputs one of input data of the demodulation circuit and output data of the demodulation circuit.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 shows a format for recording data modulated by an 8-16 modulation method;

FIG. 2 is a schematic block diagram showing a data processor according to a first embodiment of the present invention; and

FIG. 3 is a schematic block diagram showing a data processor according to a second embodiment of the present invention.

### DETAILED DESCRIPTION OF THE PREFERRED EMBODIMENTS

In the drawings, like numerals are used for like elements throughout.

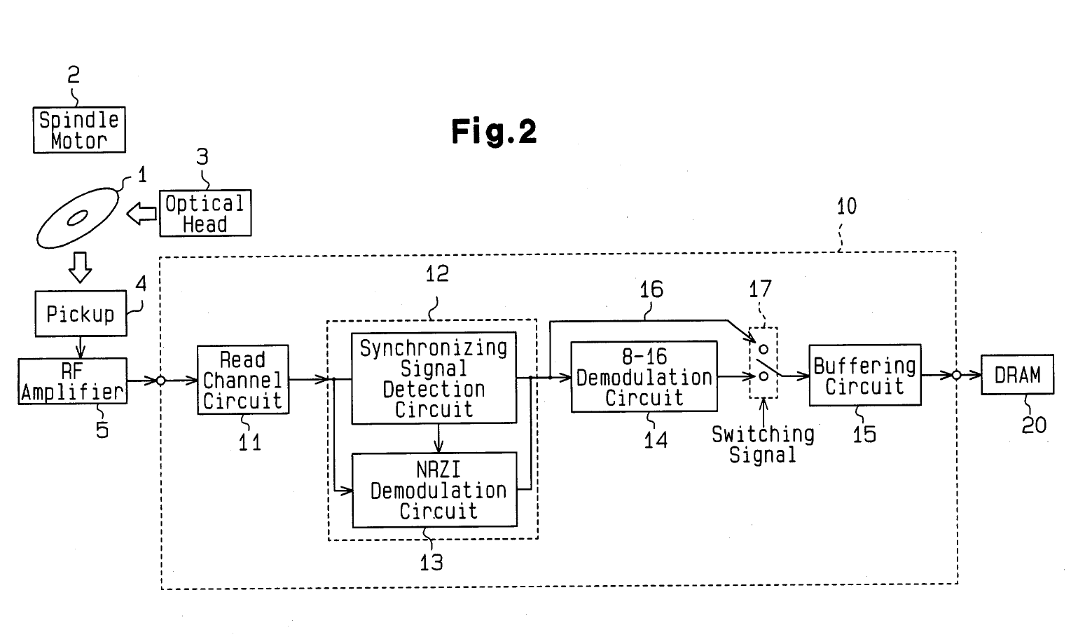

FIG. 2 is a schematic diagram of a data processor 10 according to a first embodiment of the present invention and peripheral devices of the data processor 10. The data processor 10 is applied to a data reproducer of a DVD.

An optical disc 1 (DVD) shown in FIG. 2 has a surface, in which pits are formed to record data. Information data, such as image data and music data, is modulated and recorded on the optical disc. Modulation methods include, for example, non-return to zero inverse (NRZI) modulation and 8-16 modulation.

When the NRZI modulation is performed, the condition for recording data to the optical disc is reversed each time the bit value of the digital data that is to be modulated changes to 1 (logical high level). That is, the formation of the pits on the optical disc 1 starts and stops whenever the bit value of the data changes to 1.

In 8-16 modulation, for every 8 bits of information data, 8 bits of data is converted into 16 bits of data. From 2¹⁶ (65536) patterns, 2⁸ (256) patterns are selected that are optimal for reading data. In a DVD, 8-16 modulation sets the lengths of pits, which are formed on the optical disc 1, to correspond to 3T to 14T. Here, T is the date length of 1 bit.

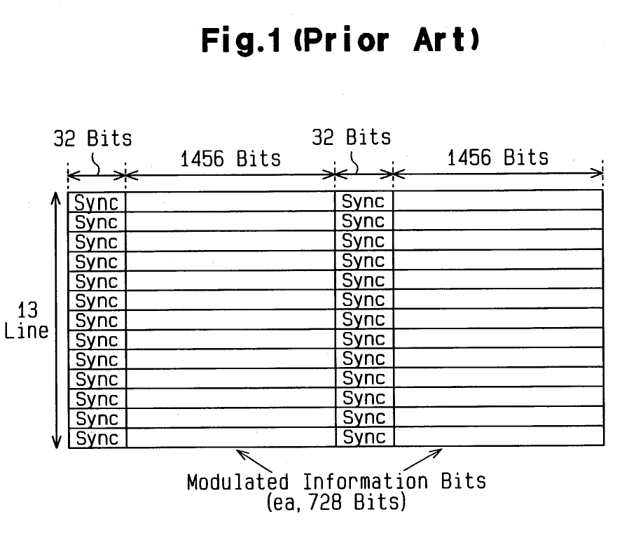

In 8-16 modulation, modulation is performed such that a code of the modulated 16-bit data is appropriately connected to a code of the newly modulated 8-bit data. More specifically, a plurality of modulation candidates (16-bit data) are prepared for each one 8-bit data. One of the modulation candidates is selectively employed by referring to a next data converting number assigned to the previous 8 bit data. Accordingly, the modulated 16-bit digital data is affected not only by the current 8-bit data but also by previously modulated 16-bit data. In 8-16 modulation, a synchronizing signal is added to the modulated 16-bit data to generate digital data in the format in FIG. 1.

In data reproduction for the optical disc 1, a laser beam from an optical head 3 is irradiated onto the optical disc 1, which is rotated by a spindle motor 2. A pickup 4 receives light reflected from the optical disc 1 and converts the reflected light into an electric signal. An RF amplifier 5 shapes the waveform of the electric signal and forms a binary electric signal. The waveform of the binary electric signal is on a high potential side when the laser beam traces the pits and on a low potential side when pits are not formed in the path of the laser beam.

The binary electric signal is input to the data processor 10. The data processor 10 demodulates the modulated data, which is recorded on the optical disc 1, into the information data prior to modulation. The demodulated information data is output to a dynamic random access memory (DRAM) 20.

The data processor 10 will now be described in detail. In the data processor 10, the binary electric signal (input signal) is input to a read channel circuit 11. The read channel circuit 11 generates a clock signal from the input signal. Together with the input signal, the clock signal is provided to a synchronizing signal detection circuit 12 and an NRZI demodulation circuit 13 to be used as a sampling clock.

The synchronizing signal detection circuit 12 extracts the synchronizing signal shown in FIG. 1 from the input signal. The detection circuit 12 extracts data that is to be demodulated from the input signal in accordance with the extracted synchronizing signal.

The NRZI demodulation circuit 13 demodulates the input signal to reconfigure the data (8-16 modulated data) recorded on the optical disc 1. The demodulation circuit 13 samples a level of the input signal in accordance with a sampling frequency, which is set in response to a clock signal generated in the read channel circuit 11. The demodulation circuit 13 sets the level of a digital signal to 0 when the sample and the previous sample have the same level and sets the level to 1 when the two samples have different levels. This generates 16-bit digital data from the input signal.

An 8-16 demodulation circuit (processing circuit) 14 performs 8-16 demodulation on the reconfigured 16-bit digital data to generate the 8-bit data prior to modulation.

The demodulated 8-bit information data is transferred to a buffering circuit 15. The buffering circuit 15 stores a predetermined amount of input data and transfers a predetermined amount of input data to a DRAM 20. The information data includes a parity for an error correction code (ECC). The DRAM 20 stores a predetermined amount of the information data and performs error correction on the information data transferred to the DRAM 20 using the parity. The data processor 10 may include circuits for correcting errors and reading data from the DRAM 20.

In the present specification, a parity for error correction and address data assigned to each predetermined amount of data are referred to as a code, and the adding of a code to data is defined as encoding. Encoding does not include modulation, and modulation does not include encoding.

Diagnosis for circuits located at the input side of the 8-16 demodulation circuit 14 in the data processor 10 will now be described.

Data read from the optical disc 1 is temporarily stored in the DRAM 20. Then, diagnosis is performed using the stored data. Since the stored data is demodulated in the 8-16 demodulation circuit 14, it is difficult to confirm the actually modulated input data as being correct.

In 8-16 demodulation, the 8-bit digital data is determined in a univocal manner from the modulated 16-bit digital data. However, since a plurality of modulation candidates are prepared for the 8-bit data, the data read from the optical disc does not correspond in a univocal manner to the data stored in the DRAM 20. For this reason, it is difficult to determine the condition of the data read from the optical disc 1. For example, when data is read erroneously and a 16-bit pattern, which coincidentally matches another candidate corresponding to the same 8-bit data, is read, it is determined that there is no read error even though there is an error.

Therefore, the data processor 10 of the first embodiment includes a bypass wire 16 and a switching circuit 17. The input data bypasses the 8-16 demodulation circuit 14 through the bypass wire 16. The switching circuit 17 selectively provides the bypassing input signal (input data of processing circuit) and the 8-16 demodulated input signal (output data of processing circuit) to the buffering circuit 15. For example, the input data that is not 8-16 demodulated is transferred to the DRAM 20 when evaluating the quality of the read channel circuit 11.

The switching circuit 17 is switched in accordance with a switching signal, as shown in FIG. 2. The switching signal is generated by, for example, a host computer (not shown), which has control over the entire DVD data recorder. The data processor 10 may include a switch (not shown), which is operated by an external device, to generate a switching signal in accordance with the operation of the switch.

The data processor of the first embodiment has the following advantages.

(1) The data processor 10 includes the bypass wire 16 and the switching circuit 17. Thus, it is possible to avoid demodulation of the data read from the optical disc in the 8-16 demodulation circuit 14 when evaluating, for example, the quality of the read channel circuit 11. More specifically, the data recorded on the optical disc 1 and the data reproduced from the optical disc 1 may be directly associated with each other and compared. This allows the condition of the data read from the optical disc 1 to be accurately acknowledged and diagnosed.

(2) The data read from the optical disc 1 is demodulated in the NRZI demodulation circuit 13. Accordingly, diagnosis of the read channel circuit 11 is conducted with binary digital data. This facilitates diagnosis.

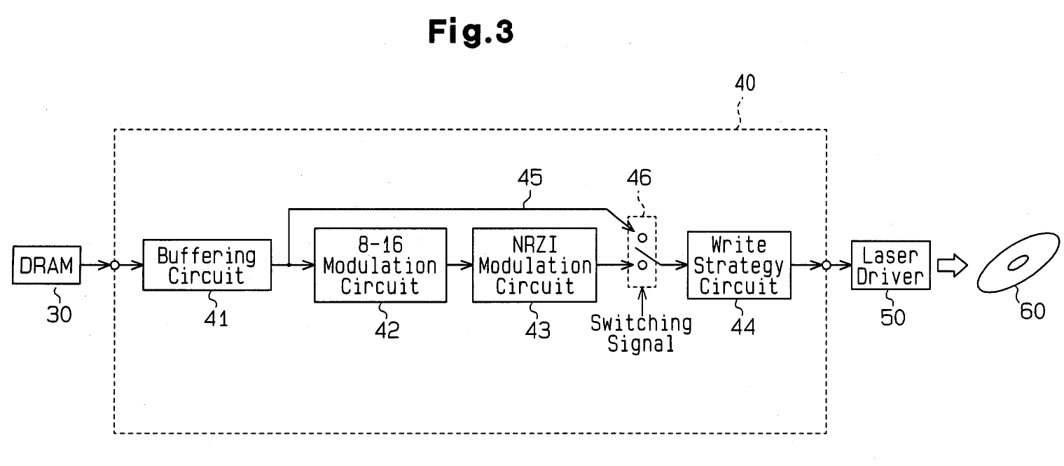

FIG. 3 is a schematic diagram of a data processor 40 according to a second embodiment of the present invention and peripheral devices of the data processor 40. The data processor 40 is applied to a DVD data recorder.

As shown in FIG. 3, a dynamic random access memory (DRAM) 30 that temporarily stores data prior to writing is connected to the DVD data processor 40. In data prior to writing, a parity for an error correction code (ECC) and data indicating an address for each predetermined length of data is added to information data that is to be recorded, such as image data, and encoded. The encoded data (information data) is recorded on an optical disc 60.

The information data stored in the DRAM 30 is modulated by the data processor 40 to generate recording data. The modulated data is converted into a laser signal by a laser driver 50 and written to the optical disc 60.

In the data processor 40, the information data provided from the DRAM 30 is temporarily sent to a buffering circuit 41. The buffering circuit 41 temporarily stores the data, which is transferred from the DRAM 30 to the data processor 40, and then sequentially provides the data to an 8-16 modulation circuit (processing circuit) 42. The buffering circuit 41 retrieves new data from the DRAM 30 when the stored data decreases to a predetermined amount while continuously outputting the data to the 8-16 modulation circuit 42.

The 8-16 modulation circuit 42 performs 8-16 modulation on the information data from the buffering circuit 41. The 8-16 modulated digital data is modulated by a NRZI modulation circuit 43 in accordance with the NRZI technique. The modulated data is recorded on the optical disc 60.

The recording data generated through the 8-16 modulation and NRZI modulation is transferred to a write strategy circuit 44. The write strategy circuit 44 sets the pulse width and pulse height value of a laser beam, which is irradiated onto the optical disc 60, in accordance with the recording data to instruct the laser driver 50 of the pulse width and pulse height value of the laser beam. The laser driver 50 irradiates the laser beam on the optical disc 60 in accordance with the instruction and records the recording data on the optical disc 60.

The diagnosis of a laser waveform, which is output from the laser driver 50, will now be described.

In the diagnosis of the laser waveform, test data, which is used as a test pattern, is normally stored on the DRAM 30 to generate a laser waveform serving as a test pattern. In this state, the test data is modulated in the 816 modulation circuit 42. Thus, it is difficult to produce test data for generating a desired test pattern. Particularly, in data modulated through 8-16 modulation, 16 bit modulated digital data is not determined in a univocal manner from the 8-bit digital data. Thus, it is difficult to produce the test data. Furthermore, the 8-16 modulated data significantly restricts the laser waveform, such as the maximum pulse width and minimum pulse width. This applies restrictions to the test pattern.

For this reason, the data processor 40 of the second embodiment includes a bypass wire 45 and a switching circuit 46. The information data provided from the buffering circuit 41 bypasses the 8-16 modulation circuit 42 and the NRZI modulation circuit 43 through the bypass wire 45 and is sent to the write strategy circuit 44. The switching circuit 46 selectively provides the bypassed information data (input data of processing circuit) and modulated information data (output data of processing circuit) to the write strategy circuit 44. The switching circuit 46 transfers the data stored in the DRAM 30 to the write strategy circuit 44 and the laser driver 50 without modulating the data.

The switching circuit 46 is switched in accordance with a switching signal, as shown in FIG. 3. The switching signal is generated by, for example, a host computer (not shown), which has control over the entire DVD data recorder. The data processor 40 may include a switch (not shown), which is operated by an external device, to generate the switching signal.

The data processor 10 shown in FIG. 2 may be used to read a test pattern. More specifically, the data processor 10 selects the bypass wire 16 to easily associate the test pattern generation data stored in the DRAM 30 with the data read from the optical disc 60.

The data processor 40 of the second embodiment has the following advantages.

(1) The data processor 40 includes the bypass wire 45 and the switching circuit 46. Accordingly, the data stored in the DRAM 30 is transferred to the write strategy circuit 44 and the laser driver 50 without undergoing 8-16 modulated when testing the accuracy for recording data on the optical disc 60. This directly associates the data set as a test pattern with the data recorded on the optical disc. As a result, the test data that generates a desired test pattern is easily produced, and the recording accuracy is easily tested.

(2) The bypassing of the NRZI modulation circuit 43 directly associates a logical waveform of the test data stored in the DRAM 30 with a laser waveform output from the write strategy circuit 44.

It should be apparent to those skilled in the art that the present invention may be embodied in many other specific forms without departing from the spirit or scope of the invention. Particularly, it should be understood that the present invention may be embodied in the following forms.

The data processor 10 does not have to include the read channel circuit 11 or the synchronizing signal detection circuit 12.

In the data processor 10, input data (read data) may further bypass the NRZI demodulation circuit 13 when evaluating the quality of the read channel circuit 11.

In the data processor 40, test data may bypass only the 8-16 modulation circuit 42 when generating a test pattern. In this case, the test data is produced beforehand to obtain a laser waveform having a desired test pattern through NRZI modulation.

The write strategy circuit 44 may set either the pulse width or pulse height value of a laser.

The data processor of the present invention may include the data processor 10 and the data processor 40. In this case, the data processors simplify the diagnosis for recording and read data.

The recording medium is not limited to a DVD disc and may be any kind of recording medium, which records modulated data, such as an appropriate optical disc (magnetic-optical disk).

Modulation is not limited to 8-16 modulation having the format illustrated in FIG. 1. Any type of modulation may be applied as long as the digital data subject to modulation (demodulation) is not determined from modulated (demodulated) data in a univocal manner.

The present examples and embodiments are to be considered as illustrative and not restrictive, and the invention is not to be limited to the details given herein, but may be modified within the scope and equivalence of the appended claims.

What is claimed is:

1. A data processor for transferring data to and from a recording medium, the data processor comprising:
a processing circuit for performing at least one of demodulation and modulation on data having a predetermined format; and
a switching circuit connected to an input and an output of the processing circuit, wherein the switching circuit outputs one of input data of the processing circuit and output data of the processing circuit.

2. The data processor according to claim 1, wherein the switching circuit outputs the one of the input data and the output data of the processing circuit in response to a switching instruction.

3. The data processor according to claim 1, further comprising:
a demodulation circuit connected to the processing circuit for demodulating the data separately from the demodulation in the processing circuit and providing the demodulated data to the input of the processing circuit.

4. The data processor according to claim 1, wherein the processing circuit performs a first modulation on the data, the data processor further comprising:
a modulation circuit connected between the processing circuit and the switching circuit for performing a second modulation on the data that has undergone the first modulation:
wherein the switching circuit outputs the one of the input data of the processing circuit and data that has undergone the second modulation.

5. The data processor according to claim 1, further comprising:
a bypass wire bypassing the processing circuit to send the input data of the processing circuit to the switching circuit.

6. A data processor for transferring data to and from a recording medium, the data processor comprising:
a modulation circuit for modulating data recorded on the recording medium;
a first switching circuit connected to an input and an output of the modulation circuit, wherein the first switching circuit outputs one of input data of the modulation circuit and output data of the modulation circuit;
a demodulation circuit for demodulating data read from the recording medium; and
a second switching circuit connected to an input and an output of the demodulation circuit, wherein the second switching circuit outputs one of input data of the demodulation circuit and output data of the demodulation circuit.

7. The data processor according to claim 6, wherein the first switching circuit outputs the one of the input data and the output data of the modulation circuit in response to a first switching instruction, and wherein the second switching circuit outputs the one of the input data and the output data of the demodulation circuit in response to a second switching instruction.

8. The data processor according to claim 6, further comprising:
a first bypass wire bypassing the modulation circuit to send the input data of the modulation circuit to the first switching circuit; and
a second bypass wire bypassing the demodulation circuit to send the input data of the demodulation circuit to the second switching circuit.
